(19) United States
(12) Patent Application Publication
(10) Pub. No.: US 2007/0277440 A1
(43) Pub. Date: Dec. 6, 2007

(54) Door opener

(76) Inventor: Paul Luetkenhaus, Gescher (DE)

Correspondence Address: GREENBLUM & BERNSTEIN, P.L.C., 1950 ROLAND CLARKE PLACE, RESTON, VA, 20191, US

(21) Appl. No.: 11/442,989

(22) Filed: May 31, 2006

(51) Int. Cl. E05F 15/00

(52) U.S. Cl. 49/139

(57) ABSTRACT

A device for actuating doors, with a motor and a door opening lever that can be actuated by the motor and connected to the door to be opened, whereby a decoupling device is arranged between motor and door-opening lever to support a decoupling of the door-opening lever from the drive in the case of an opening of the door not caused by the motor, and a door closer acting on the door to be actuated, whereby the decoupling device is arranged outside of the door closer.

### BACKGROUND OF THE INVENTION

1. Field of the Invention

The invention relates to a motor-driven door opener.

2. Discussion of Background and Relevant Information

Power-driven door openers are used, for example, for large doors and for doors used by disabled persons, such as doors in hospitals and in public buildings and the like. Such door openers typically include a drive, such as a hydraulic drive or an electric drive, which provide for the opening and closing of the door by means of the actuation of a switch, for example. During a power failure, such as, e.g., in the case of a fire, a door equipped with a door opener of this type cannot longer be opened in an electromotive manner; instead, the door must be opened manually.

However, with known door openers manual opening involves a significant force, as when the door is opened, a force must be applied manually not only against the door closer or the return spring of the door opener, but when the door is opened manually, the opening movement is transferred to all parts of the door opener. That is, when the door is opened manually, both the return spring of the door opener and the actual drive, possibly including a transmission, are also moved, so that the opening forces can be so high that the door can no longer be opened manually or, at least, not by frail or disabled persons.

### SUMMARY OF THE INVENTION

Therefore, the invention embodies a door opener such that in a purely manual opening of the door the forces required are relatively small, so that the door can be easily opened, and such that the door opener can be produced in a particularly cost-effective manner.

More particularly, the invention includes a decoupling device arranged between a door-opening motor, or motor, and a door-opening lever so as to decouple the door-opening lever from the drive in the event of the need for an opening of the door not caused by the motor, with a door closer acting on the door to be actuated, whereby the decoupling device is arranged outside of the door closer.

The decoupling device being arranged outside of the door closer, in such an embodiment of the invention, has the advantage that the door closer can be a commercially available standard component and a particular design of the door closer is not required. A particularly cost-effective production of the door opener can thus be achieved.

The invention encompasses various particular embodiments.

In one advantageous embodiment of the invention, the force of the motor is transferred to the door-opening lever by means of a flexible component that is embodied in a force-transmitting manner in the case of a driving force from the motor in the direction of the door to be opened—under tension—and that when under compressive stress it does not transmit any force, or a very small force, with a reversed drive force—with a manual opening of the door. A flexible component of this type can be embodied in a cost-effective and sturdy manner as, e.g., a chain, rope, cable, or band.

In order to ensure a high operational reliability in each operating state of the device, it can be advantageous to provide for a tension spring that acts on the flexible component, i.e., that is embodied in a tensioning manner, so that even when the flexible component is under a compressive stress, it is tightened by the spring, in order to thus prevent tangling, for example.

In an advantageous embodiment the flexible component is arranged between a transmission acted on by the motor and the door-opening lever, in order to be able to open even heavy doors by means of the transmission support of the motor with small motor performances and small space requirements.

The flexible component itself can already be a decoupling device, as it cannot transfer any or can transfer only small forces under compressive stress, i.e., in the case of a manual opening of the door.

However, decoupling devices of a different type can be provided as well, such as, e.g., a cam driven at least indirectly by the motor, the movement of which cam is transferred to the door-opening lever and leads to an opening of the door caused by the motor, whereby the door-opening lever is embodied in a movable manner vis-à-vis the cam in the case of a manual opening of the door, so that such a movement does not have an impact on a movement of the cam in the case of a manual opening of the door. The cam is embodied in an advantageous manner such that it acts merely on one side of the door-opening lever.

If the cam is arranged on a gear wheel or a pulley, whereby the gear wheel can be driven, e.g., via a chain, by the motor, or the pulley can be driven via a rope, cable, or a band, a cost-effective and still sturdy embodiment of the invention is rendered possible.

A further decoupling device is achieved when a cam is connected at least indirectly to the door-opening lever and is arranged in a recess of an actuating body driven by the motor, so that the cam and the door-opening lever connected thereto can be brought into its opening position when such actuating body is motor-driven; but because the recess of the actuating body is larger than the cam, the cam can move freely in the recess in the case of a manually caused opening movement of the door, and the manually caused door-opening movement thus does not have any impact on a force transfer to the actuating body. The recess can thereby be embodied, e.g., as an elongated hole, and the actuating body can again be embodied as a gear wheel or pulley, whereby the gear wheel can be actuated via a chain by the motor or the pulley can be actuated via a band or via a band driven at least indirectly by the motor.

The gear wheel or the pulley can be arranged in a space-saving manner on a shaft of the door-opening lever.

In an advantageous embodiment the decoupling device can also be comprised as a retaining body that can be driven or moved by a motor and in which a force transfer element is guided in a movable manner, which element is, in turn, connected at least indirectly to the door-opening lever, whereby the movement of the force transfer element is limited by a stop arranged on the force transfer element and supported on the retaining body in the case of a driving force emanating from the motor.

The force transfer element can be, e.g., a flexible component, i.e., for instance a chain or a rope or cable, and a pull rod can be provided at the motor-facing end of this flexible component, which pull rod is guided in a movable manner in a bore of a plate serving as a retaining body.

In general, a door opener is disclosed to decouple the drive of the door opener in the case of a manual opening of the door during such opening movement, and in particular to embody the decoupling such that the actual door closer can remain unchanged in its construction, i.e., so that standard door closer can be used without modification and the decoupling can take place in an advantageous manner where the lever extending from the door to be actuated is connected to the door opener.

Other exemplary embodiments and advantages of the present invention may be ascertained by reviewing the present disclosure and the accompanying drawings.

### BRIEF DESCRIPTION OF THE DRAWINGS

The present invention is further described in the detailed description which follows, in reference to the noted plurality of drawings by way of non-limiting examples of exemplary embodiments of the present invention, in which like reference numerals represent similar parts throughout the several views of the drawings, and wherein:

FIG. 1 illustrates a door opener according to the invention;

FIG. 2 shows the door opener of FIG. 1, partially broken-away, showing the door-opening lever decoupled from the door-opening drive during a manual opening of the door;

FIGS. 3 and 4 illustrate perspective views of the door opener of FIGS. 1 and 2, respectively;

FIG. 5 illustrates a portion of a further exemplary embodiment of the invention;

FIG. 6 a further exemplary embodiment of the invention in a closed door position; and

FIG. 7 illustrates the embodiment of FIG. 6 in an opened door position.

### DETAILED DESCRIPTION OF THE INVENTION

The particulars shown in the drawings and described herein are to be considered exemplary of the invention and are presented for purposes of illustrative discussion of various embodiments of the invention only and are presented in the cause of providing what is believed to be the most useful and readily understood description of the principles and conceptual aspects of the invention. In this regard, structural details such exemplary embodiments of the invention are shown and described in sufficient detail to make apparent to one skilled in the art of the invention a fundamental understanding of the invention sufficient so that the claimed invention, including several forms thereof, can be made and used by one skilled in the art.

Regarding FIG. 1, at first a door opener 1 is shown that has a drive 2, or motor, via which in this exemplary embodiment a cable roller 3, or drum, can be put into rotation, which roller acts on a further cable roller 5 via a linear transmission 4 formed in this exemplary embodiment by cables, which roller 5 is, in turn, connected to a plate 6. When the motor 2 is operated, the cable roller 5 together with the plate 6 is drawn in the direction of the cable roller 3, and this movement pulls on a chain 7 which drives a gear wheel 8. The gear wheel is located on a shaft 9 which, on the one hand, leads to the door closer 10, and on the other hand, a lever or door-opening lever 11 is arranged on the outer end of the shaft 9 facing away from the door closer 10, which lever is connected to the door to be opened, if necessary, via further levers. The door closer 10 can be of conventional construction, provided to close the door following a power-driven opening thereof.

When the lever 11 pivots out of the position shown in FIG. 1, the door (not illustrated) is opened, whereby in this case the lever 11 is pivoted in the direction shown by the arrow 12 and the pivoting of the lever 11 takes place against the force of the door closer 10. Subsequently, from the opened position, the door is again moved to the closed position via the lever 11, the lever pivoting in a direction opposite to that of the arrow 12.

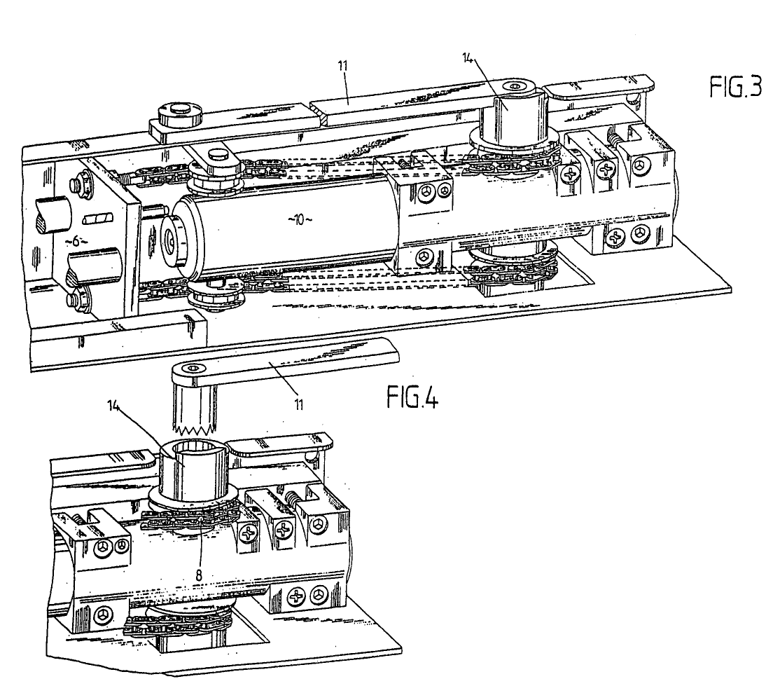

The gear wheel 8 has on its upper side a cam 14 that extends into the plane of movement of the lever 11, so that the cam 14 is embodied to limit the range of movement of the lever 11. Reference is made to the perspective views of FIGS. 3 and 4, whereby the lever is shown displaced upwardly away from the cam 14 for convenience in illustrating the upper portion of the cam in this embodiment.

If the opening of the door to be actuated is now to be supported by the motor, the plate 6 is shifted in the direction of the cable roller 3 which tensions the chain 7 and causes a rotation of the gear wheel 8 together with the cam 14 connected for rotation with the gear wheel 8. The cam 14 is pressed against the side of the lever 11 and pushes the lever 11 in the arrow direction 12 and thus causes an opening of the door to be actuated. After the door has been opened, the door closer 10 shuts the door via the lever 11.

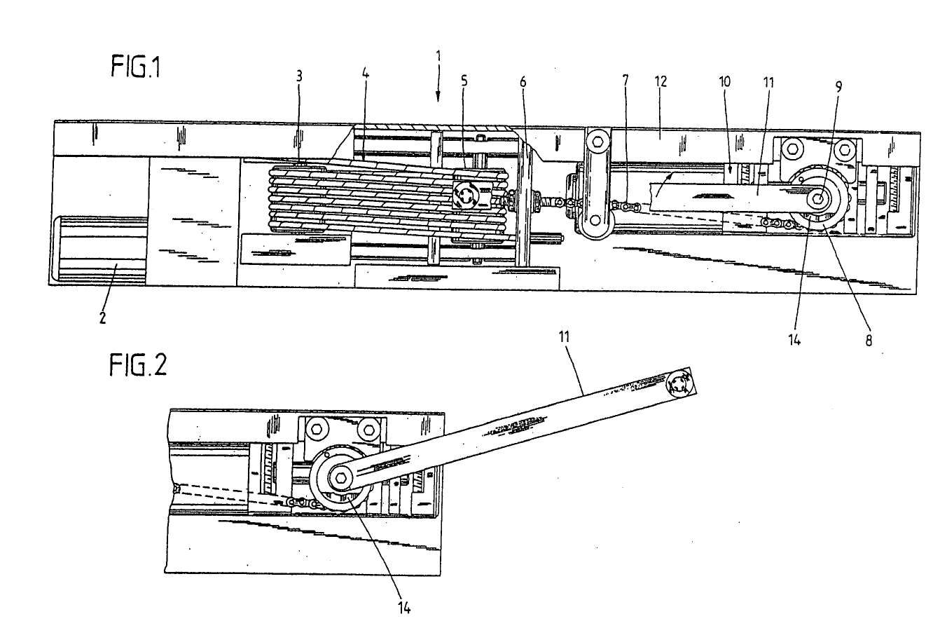

If the motor 2 were to fail, e.g., in the case of a fire or power failure, the door can be opened manually quite simply. In such a case, the door is opened manually, whereby the opening of the door causes the lever 11, which is connected to the door, to be pivoted in the direction of the arrow 12. FIG. 2 shows the position of the lever 11 when the door is opened, and, because the cam 14 is not acted on by the lever 11 in this manual, non-powered opening of the door, a decoupling of this manual opening movement from the motor drive of the door opener thus takes place, i.e., neither the gear wheel 8 nor the chain 7 nor further drive-side parts of the door opener, such as, e.g., the linear transmission or the motor, etc., are moved in the manual opening, nor are they required to be moved during such manual opening.

FIGS. 2 and 4 show the door opener in a position whereby the door has been pivoted by 90° relative to its position with the door opener positioned as shown in FIGS. 1 and 3.

Any other suitable transmission can be used instead of a linear transmission 4 and it is further possible to use a door opener without a transmission. It is also possible to employ a force transfer between lever 11 and motor 2 other than in the form of the chain 7, e.g., in the form of cables or other transfer devices.

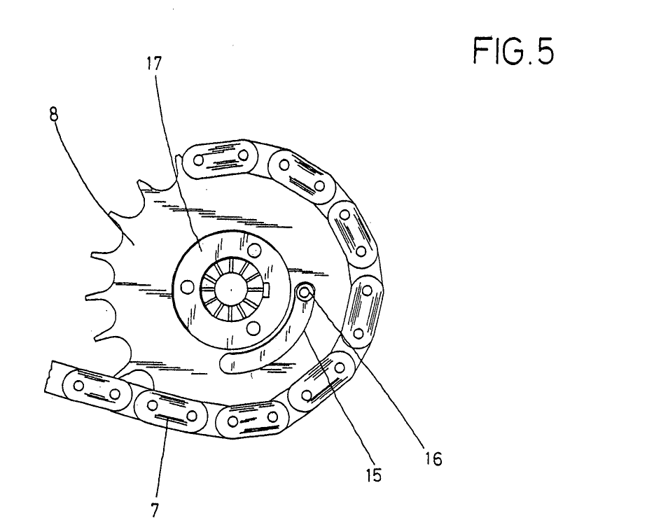

Furthermore, different types of decoupling between manually actuated lever 11 and door closer 10 can also be used. It is possible, e.g., to embody the gear wheel 8 in a particular manner instead of the cam 14, so that the gear wheel renders possible a decoupling of the lever 11 from the motor drive in the case of a manual actuation of the lever 11 or of the door connected thereto. A possible embodiment of the gear wheel 8 is shown in FIG. 5. The gear wheel 8 has an elongated hole 15, or slot, in which a cam 16 of a disk 17 arranged in a movable manner on the gear wheel 8 is guided. On the one hand, the disk 17 is connected to the door closer 10 and, furthermore, the lever 11 is connected to the disk 17. In a motor-driven opening of the door, the gear wheel 8 in this exemplary embodiment is put into rotation via the chain 7 until the end of the elongated hole 15 strikes against the cam 16, and subsequently also pivots the lever 11 connected to the disk 17 in a further rotation of the gear wheel 8 and thus opens the door.

In a manual opening of the door or the lever 11 arranged on it, the disk 17 is rotated via the lever 11, and the cam 16 merely shifts within the elongated hole 15, and thus a decoupling of the manual opening movement also takes place once again in this exemplary embodiment, which movement is transferred to the lever 11 by the drive of the door opener or by the force transfer elements connected to the drive.

The exemplary embodiments shown above are merely two possible ways for in particular a mechanical decoupling of the door opening movement from the motor drive or the transfer elements of the door opener.

Ideally, the manual opening of the door would thereby be facilitated in that a twofold decoupling takes place, namely a first decoupling of the door opening movement from the motor drive (as shown in the foregoing two exemplary embodiments) and a second decoupling of the opening pivoting movement of the lever 11 from the actual door closer 10, so that it is not necessary to work against the return spring of the door closer 10 in a manual opening of the door.

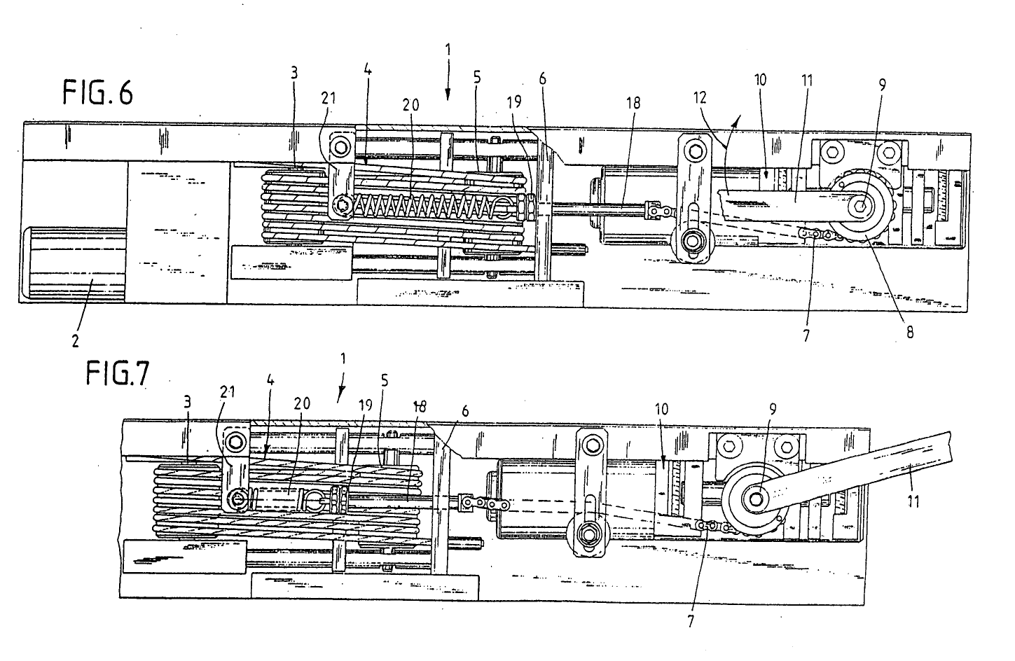

A further example of the invention is shown in FIGS. 6 and 7. FIG. 6 shows the construction, already explained above, of a door opener 1 that can be operated by a motor, which door opener also renders it possible to achieve an opening of the door to be actuated through the motor 2 via the linear transmission 4, whereby the linear transmission 4, in turn, draws the plate 6 in the direction of the cable roller 3 when the motor 2 is actuated. A pull rod 18 is connected to the plate 6, which rod is arranged in a shiftable manner in a corresponding bore existing in the plate 6. The one end of this pull rod 18 projects through the plate 6 in the direction of the motor 2, and a blocking element is arranged on the end of the pull rod 18, which element prevents the pull rod 18 from being drawn through in the direction of the door closer 10. A screw nut 19 fixed by a locknut is provided as a blocking element in this exemplary embodiment, which screw nut is embodied to have a circumference larger than the diameter of the pull rod 18, and the screw nut 19 is also embodied to have a circumference larger than the opening in the plate 6 for the pull rod 18.

At the opposite end of the pull rod 18, this rod is connected to the chain 7, as shown in the drawing figures.

Furthermore, the pull rod 18 is connected on the end facing the motor 2 to a pulling device, in this exemplary embodiment to a spring 20 held by a fastener 21.

FIG. 6 shows the position of the door closer with closed door. When the door is opened, the plate 6 is moved by the motor 2 in the direction of the cable roller 3, and the pull rod 18 with the chain 7 arranged on it is also drawn in the direction of the cable roller 3 on account of the counter bearing formed by the screw nut 19, and this movement is transferred via the chain 7 to the gear wheel 8 connected indirectly or directly to the lever 11, so that the lever 11 is moved in the direction of the arrow 12 when the motor 2 is operated and causes an opening of the door.

If, with the embodiment shown in FIGS. 6 and 7, the door is pulled open by hand, e.g., in the case of a power failure, the door opener 1 is in the position shown in FIG. 7. In this position, the door with the lever 11 arranged on it indirectly or directly is pushed into the position according to FIG. 7, and the pull rod 18 is moved in the direction of the fastener 21 through the action of the spring 20 and prevents the chain 7 from being damaged or a failure of the entire door opener 1 through a disordered entangling of the chain 7. A decoupling of the manual opening movement thus takes place again, which movement is transferred by the motor 2 and the transmission 4 through the lever 11 to the door opener, and a commercially available door closer 10 can still be used. This is a cost-effective and sturdy way of decoupling this manual opening movement from the motor drive of the door opener.

In addition, a systematic guidance of the chain in a manual actuation of the door to be opened can also be effected in a different way, e.g., by using a corresponding chain tensioner that acts on the chain and is arranged, e.g., between plate 6 and gear wheel 8 and prevents the chain from “sagging” when the door is opened manually.

Any other suitable transfer link can also be used instead of the chain, e.g., a cable, a rod or the like can be used.

A decoupling has again been rendered possible by the embodiment according to FIGS. 6 and 7, which allows the use of standard components and is arranged outside of the actual door closer 10.

The foregoing examples have been provided merely for the purpose of explanation and are in no way to be construed as limiting of the present invention. While the present invention has been described with reference to an exemplary embodiment, it is understood that the words which have been used herein are words of description and illustration, rather than words of limitation. Changes may be made, within the purview of the appended claims, as presently stated and as amended, without departing from the scope and spirit of the present invention in its aspects. Although the present invention has been described herein with reference to particular means, materials and embodiments, the present invention is not intended to be limited to the particulars disclosed herein; rather, the present invention extends to all functionally equivalent structures, methods and uses, such as are within the scope of the appended claims.

1. A door opening device, said device comprising:
a motor;
a door-opening lever operably connected to the motor for actuation by the motor, said door-opening lever being adapted to be connected to a door to be opened;
a door closer adapted to act upon the door;
a decoupling device arranged between the motor and the door-opening lever for decoupling the door-opening lever from the motor for allowing an opening of the door not caused by the motor;
the decoupling device being arranged outside of the door closer.

2. A door opening device according to claim 1, further comprising:
a flexible component for transferring a driving force from the motor to the door-opening lever;
the flexible component being embodied in a force-transmitting manner only in the case of a driving force from the motor in a door-opening direction.

3. A door opening device according to claim 2, wherein:
said flexible component comprises a chain.

4. A door opening device according to claim 2, wherein:
said flexible component comprises a cable or a band.

5. A door opening device according to claim 2, further comprising:
a tension spring embodied to act on the flexible component.

6. A door opening device according to claim 2, wherein:
the flexible component is arranged between a transmission acted on by the motor and the door-opening lever.

7. A door opening device according to claim 1, wherein:
the decoupling device is embodied as a flexible component.

8. A door opening device according to claim 1, wherein:
the decoupling device comprises a movable cam arranged to be driven by the motor and to act on the door-opening lever for moving the door-opening lever in a door-opening direction;
the door-opening lever is arranged to be movable relative to the cam during the opening of the door not caused by the motor.

9. A door opening device according to claim 8, wherein:
the cam is embodied to act on only a single side of the door-opening lever.

10. A door opening device according to claim 8, wherein:
the cam is arranged on a gear wheel or a pulley.

11. A door opening device according to claim 1, wherein:
the coupling device comprises a movable cam arranged to be driven by the motor and connected at least indirectly to the door-opening lever;
an actuating body is driven by the motor during motor-driven door opening, said actuating body including a recess;
the cam is arranged in the recess of the actuating body to drive the cam during the driving of the actuating body by the motor during the motor-driven door opening;
the recess is larger than the cam, so that the cam together with the door-opening lever arranged on the cam is guided in the recess in a movable manner.

12. A door opening device according to claim 11, wherein:
said recess is an elongated hole.

13. A door opening device according to claim 11, wherein:
the actuating body is a gear wheel or a pulley.

14. A door opening device according to claim 13, wherein:
the gear wheel or the pulley is connected to a shaft of the door-opening lever.

15. A door opening device according to claim 1, wherein:
the decoupling device comprises a retaining body arranged to be driven by the motor and connected at least indirectly to the door-opening lever by means of a force transfer element for guiding the door-opening lever in a door-opening direction;
movement of the force transfer element is limited by a stop arranged on the force transfer element and supported on the retaining body during a driving force of the motor.

16. A door opening device according to claim 15, wherein:
said retaining body comprises a plate with a bore, said force transfer element being guided within said bore.

17. A door opening device according to claim 16, further comprising:
a pull rod having a motor-facing end, said stop being arranged on said motor-facing end of the pull rod.

18. A door opening device according to claim 17, further comprising:
a chain or a cable arranged on the door-facing end of the pull rod.
